(19) United States
(12) Patent Application Publication
(10) Pub. No.: US 2010/0185853 A1
(43) Pub. Date: Jul. 22, 2010

(54) LOCAL AREA NETWORK ARCHITECTURE

(75) Inventor: Kim-Yeung Sip, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN FRECISION INDUSTRY (ShenZhen) CO., LTD., Shenzhen City (CN); HON HAI PRECISION INDUSTRY CO., LTD., Tu-Cheng (TW)

(21) Appl. No.: 12/482,401

(22) Filed: Jun. 10, 2009

(30) Foreign Application Priority Data
Jan. 16, 2009 (CN) 200910300217.3

(51) Int. Cl. H04L 29/06; H04L 9/28

(52) U.S. Cl. 713/165; 380/28

(57) ABSTRACT

The present disclosure provides a local area network architecture including a server, a client and a data transfer system. The server uses a first operating system and includes an encryption chip and a server memory storing the encrypted files. The encryption chip includes an encryption system having a different operating environment with the first operating system. The encryption system includes a file converting module and an encryption module. The file converting module converts files to a format only recognizable for the encryption system and unrecognizable for the first operating system. The encryption module encrypts the converted files. The client uses a second operating system and includes a client memory storing the files from the server and a decryption chip. The decryption chip uses a decryption system including a file reverting module and a file decryption module. The data transfer system transmits files from the server to the client.

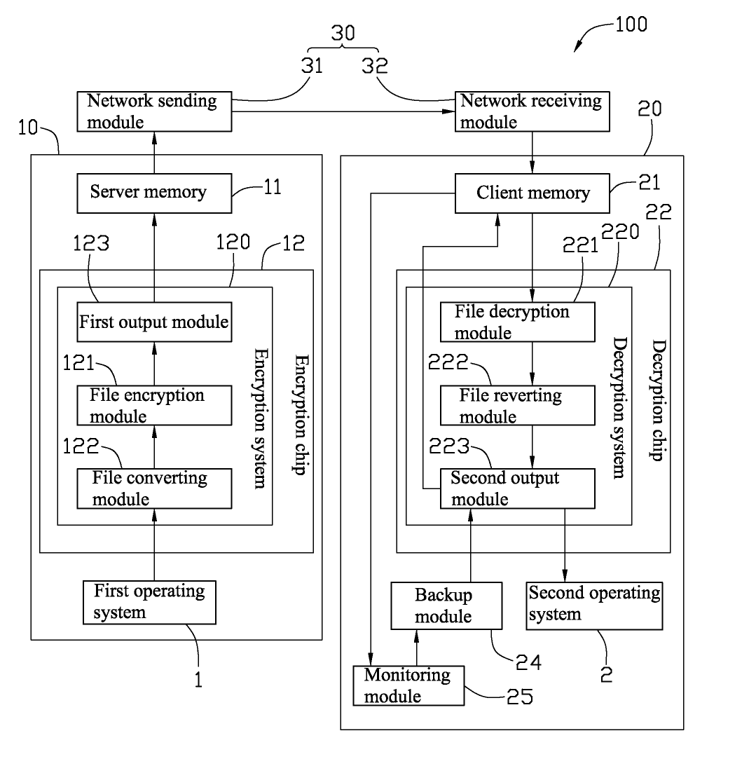

### BACKGROUND

1. Technical Field

The present disclosure relates to network architectures, and in particularly, relates to a local area network architecture capable of improving security of the network.

2. Description of Related Art

To save resources and possibly enhance work efficiency, the paperless office is advocated. As such, most businesses work online, and download all information or files from servers. However, securing the local area network of the business from threats such as viruses is a challenge.

What is needed, therefore, is a local area network architecture capable of improving file safety to overcome or at least alleviate the above-described problem.

### BRIEF DESCRIPTION OF THE DRAWING

Many aspects of the present local area network architecture can be better understood with reference to the following drawing. The components in the drawing are not necessarily drawn to scale, the emphasis instead being placed upon clearly illustrating the principles of the present local area network architecture.

The FIGURE is a functional block diagram of a local area network architecture according to an exemplary embodiment.

### DETAILED DESCRIPTION

Embodiments of the present disclosure will now be described in detail below, with reference to the accompanying drawing.

Referring to the FIGURE, a local area network (LAN) architecture 100, according to an exemplary embodiment, is shown. The local area network architecture 100 includes a server 10, a client 20, and a data transfer system 30. The data transfer system 30 includes a network sending module 31 and a network receiving module 32.

The server 10 includes a server memory 11 and an encryption chip 12. In the present embodiment, the server memory 11 is a hard disc. A first operating system 1 is installed in the server 10. The first operating system 1 can be Windows®, Unix®, or an Apple® Computer Inc. operating system. In the present embodiment, the operating system 1 is the Windows® operating system. Files are encrypted then stored in the server memory 11. In the present embodiment, the encryption chip 12 is read-only to prevent the encryption chip 12 from being compromised.

The encryption chip 12 employs an encryption system 120. The encryption system 120 is a different operating environment with the first operating system 1. The encryption system 120 is compiled by supplier, and independent of the first operating system 1. The encryption system 120 includes a file encryption module 121, a file converting module 122, and a first output module 123. The file converting module 122 is configured for converting the files to files in a format (hereafter unrecognizable files) that can be only be recognized by the encryption system 120 and unrecognized by the first operating system 1 before the files are encrypted. The encryption system 120 can recognize the file converted by the file converting module 122 from the first operating system 1. Then the unrecognizable files are stored in the server memory 11. The encryption module 121 is configured for encrypting the files in the unrecognizable format, that is, that files that are unrecognizable to the first operating system 1 and converted by the file converting module 122. The encryption module 121 can adopt a scrambling algorithm or use a hardware serial number of the server 10 to encrypt the files. In the present embodiment, the encryption module 121 uses the scrambling algorithm to encrypt the files. The first output module 123 is configured for outputting the encrypted files from the encryption system 120 to the server memory 11.

The network sending module 31 is digitally coupled to the server 10. The network sending module 31 is configured for sending the encrypted files from the server memory 11 to the client 20.

The client 20 includes a client memory 21, a decryption chip 22, a backup module 24, and a monitoring module 25. A second operating system 2 is installed in the client 20. The second operating system 2 can be Windows®, Unix®, or Apple® Computer Inc. operating system. The second operating system 2 can be the same as or different from the first operating system 1. In the present embodiment, the second operating system 2 is Windows® operating system which is same as the first operating system 1.

The network receiving module 32 is electrically coupled to the client 20. The network receiving module 32 is configured for receiving the encrypted files sent from the server 10 and storing the encrypted files into the client memory 21. The decryption chip 22 employs a decryption system 220. The decryption system 220 is a different operating environment with the second operating system 2. In the present embodiment, the decryption chip 22 is read-only to prevent the decryption chip 22 from being compromised. The decryption system 220 includes a file decryption module 221, a file reverting module 222 and a second output module 223. The decryption system 220 is compiled by the supplier of the server client and independent of the second operating system 2. The encryption system 120 can only recognize the file converted by the file converting module 122 from the first operating system 1. The file decryption module 221 corresponds to the encryption module 121 and is configured for decrypting the encrypted files stored in the client memory 21 to decrypted files. The file reverting module 222 is configured for reverting the format of the decrypted files to a recognizable format to the second operating system 2. The second output module 223 is configured for outputting the files in a recognizable format (hereafter reverted files) reverted by the file reverting module 222 to the client memory 21 and the second operating system 2. In the present embodiment, the backup module 24 controls the second output module 223 to output reverted files to the client memory 21. The monitoring module 25 is configured for monitoring the integrity of the files stored in the client memory 21. When the files stored in the client memory 21 become infected by viruses, the monitoring module 25 invokes the backup module 24. In the present embodiment, the monitoring module 25 reads the files stored in the client memory 21 and the corresponding encrypted files stored in the client memory 21, then compares them. If the stored files are damaged or modified maliciously, the monitoring module 25 invokes the backup module 24 to recover the damaged files.

In the present embodiment, the local area network architecture converts the files to an unrecognizable format for the operating systems and only recognizable by the encryption system and decryption system, as a result the files cannot be, or difficult to be recognized and become a target file type by virus written for the operating systems. Thus, the local area network architecture can improve the security of files.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A local area network architecture comprising:
a server with a first operating system installed therein, the server comprising:
an encryption chip comprising an encryption system being a different operating environment from the first operating system, the encryption system comprising a file converting module for converting files to a format recognizable only for the encryption system and an unrecognizable format for the first operating system, and an encryption module configured for encrypting the files converted by the file converting module; and a server memory capable of storing the files encrypted by the encryption module;
a client with a second operating system installed therein, the client comprising:
a client memory configured for storing the files received from the server; and a decryption chip comprising a decryption system being a different operating environment with the second operating system, the decryption system comprising a file decryption module configured for decrypting the files stored in the client memory and a file reverting module configured for reverting the format of the decrypted files to a recognizable format for the second operating system; and
a data transfer system electrically coupling the server and the client, and configured for transmitting files from the server to the client.

2. The local area network architecture as claimed in claim 1, wherein the encryption chip further comprises a first output module configured for outputting the files encrypted by the encryption system into the server memory.

3. The local area network architecture as claimed in claim 1, wherein the decryption chip further comprises a second output module configured for outputting the files reverted by the decryption chip into the client memory and the second operating system.

4. The local area network architecture as claimed in claim 3, wherein the client further comprises a backup module configured for controlling the second output module to output the reverted files to the client memory.

5. The local area network architecture as claimed in claim 4, wherein the client further comprises a monitoring module configured for monitoring the integrity of the files stored in the client memory and invoking the backup module if the stored files are destroyed.

6. The local area network architecture as claimed in claim 1, wherein the encryption module uses a scrambling algorithm to encrypt the files.

7. The local area network architecture as claimed in claim 1, wherein the data transfer system comprises a network sending module electrically coupled to the server and configured for sending the encrypted files to the client, and a network receiving module electrically coupled to the client and configured for receiving the files from the server and storing the files into the client memory.

8. The local area network architecture as claimed in claim 1, wherein the first operating system and the second operating system are all selected from one of Windows®, Unix®, and Apple® Computer Inc. operating systems.

9. The local area network architecture as claimed in claim 1, wherein the first operating system and the second operating system are same.

10. The local area network architecture as claimed in claim 1, wherein the first operating system and the second operating system are different.

11. The local area network architecture as claimed in claim 1, wherein the encryption chip and the decryption chip are read-only.

12. A transmitting system for transmitting files from a first port to a second port in a local area network, the transmitting system comprising:
a first operating system and an encryption chip installed in the first port, the encryption chip comprising an encryption system being a different operating environment with the first operating system, the encryption system comprising a file converting module for converting files to a format recognizable only for the encryption system and an unrecognizable format for the first operating system, and an encryption module configured for encrypting the files converted by the file converting module; and
a second operating system and a decryption system installed in the second port, the decryption system being a different operating environment with the second operating system and comprising: a file decryption module operable of decrypting the file received from the encryption system and a file reverting module operable of reverting the format of the decrypted file to a recognizable format for the second operating system.

13. The transmitting system as claimed in claim 12, wherein the transmitting system further comprises a first memory for storing the encrypted file.

14. The transmitting system as claimed in claim 13, wherein the encryption system further comprises a first output module operable for outputting the encrypted file to the first memory.

15. The transmitting system as claimed in claim 12, wherein the transmitting system further comprises a second memory for storing the file received from the first port.

16. The transmitting system as claimed in claim 15, wherein the decryption system further comprises a second output module operable for outputting the decrypted file to the second memory and the second operating system.

17. The transmitting system as claimed in claim 16, wherein the decryption system further comprises a backup module operable for controlling the second output module to output the reverted file to the second memory.

18. The transmitting system as claimed in claim 17, wherein the decryption system further comprises a monitoring module operable of monitoring the integrity of the file stored in the second memory and invoking the backup module again if the stored file is destroyed.
